(19) United States
(12) Patent Application Publication
(10) Pub. No.: US 2009/0104499 A1
(43) Pub. Date: Apr. 23, 2009

(54) FUEL CELL POWER GENERATING SYSTEM AND METHOD OF MANUFACTURING THE SAME

(76) Inventors: Yuusuke SATO, Tokyo (JP); Masato Akita, Yokohama-shi (JP); Takuya Hongo, Kawasaki-shi (JP); Ryosuke Yagi, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/339,146

(22) Filed: Dec. 19, 2008

Related U.S. Application Data
(63) Continuation of application No. PCT/JP08/66502, filed on Sep. 8, 2008.

(30) Foreign Application Priority Data
Sep. 25, 2007 (JP) 2007-247405

(51) Int. Cl. H01M 8/10; H01M 8/04

(52) U.S. Cl. 429/30; 29/623.1

(57) ABSTRACT

A fuel cell system has a membrane electrode composite including an anode, cathode and an electrolyte membrane sandwiched between the anode and the cathode. A lyophobic porous member is located adjacent to the anode, and an anode channel plate is also located adjacent to the porous member. A gas recovery channel and a fuel supply channel are formed in the anode channel plate, gas generated at the anode side is recovered in the gas recovery channel and a liquid fuel is supplied to the anode through the fuel supply channel. The generating system also includes a circulating system along which the fuel circulates, and a fuel supply section that supplies fuel to the circulating system.

### CROSS REFERENCE TO RELATED APPLICATIONS

This is a Continuation Application of PCT Application No. PCT/JP2008/066502, filed Sep. 8, 2008, which was published under PCT Article 21(2) in English.

This application is based upon and claims the benefit of priority from prior Japanese Patent Application No. 2007-247405, filed Sep. 25, 2007, the entire contents of which are incorporated herein by reference.

### BACKGROUND OF THE INVENTION

1. Field of the Invention

The present invention relates to a fuel cell system that supplies a liquid fuel directly to an electrode, and a method of manufacturing the cell power generating system.

2. Description of the Related Art

Some fuel cells are of a direct type in which a liquid fuel such as alcohol is supplied directly to a power generating section. The direct fuel cell requires no auxiliary device such as a vaporizer or a reformer and is thus expected to be utilized for small-sized power sources for portable devices and the like. A known power generating system utilizing such a direct fuel cell is a circulatory fuel cell power generating system that supplies a water solution of alcohol directly to a power generating section to extract protons, while circulating effluents such as water which are discharged from the power generating section, to a mixing tank or the like located upstream of the power generating section for reuse.

A direct methanol supply fuel cell (DMFC) comprises a cell stack (power generating section) in which power generating cells each comprising an anode, a cathode, and a membrane electrode assembly (MEA) are stacked. The cell stack generates power. A mixed solution of water and methanol is fed to the anode via a solution-sending pump or the like. Reaction expressed by Formula (1) occurs on the anode side to generate carbon dioxide. On the other hand, air is fed to the cathode via an air supply pump or the like. Reaction expressed by Formula (2) occurs on the cathode side to generate water.

CH₃OH+H₂O→CO₂+6H++6e− (1)

3/2O₂+6H++6e−→3H₂O (2)

CO₂ generated in the anode and the mixed solution of water and unreacted methanol are discharged from the anode as a gas-liquid two-phase stream. The gas-liquid two-phase stream discharged from the anode is separated into a gas and a liquid by a gas-liquid separator provided in a channel on an outlet side of the anode. The liquid separated by gas-liquid separator is circulated to the mixing tank or the like via a recovery channel. The separated gas is emitted to the atmosphere.

However, in a system in which the gas-liquid separator is provided in the channel on the outlet side of the anode, the gas-liquid two-phase stream flows through an anode channel and the channel on the anode outlet side. This disadvantageously increases a possible pressure loss in anode channel. Furthermore, since the gas-liquid separator is located in the system, a large-sized anode circulating section is required. This disadvantageously makes a reduction in the size of the system difficult.

A known technique for reducing the size of the direct fuel cell is a structure in which a porous membrane is interposed between a fuel supply channel located adjacent to a diffusion layer in the anode electrode to supply a fuel and a separator provided with a discharge channel along which generated gas is discharged, as disclosed in, for example, JP-A 2006-49115 (Kokai).

However, according to the above-described patent document, gas may mix into the liquid fuel flowing through the fuel supply channel to generate a gas-liquid two-phase stream. Disadvantageously, this may increase the volume and thus the flow velocity of the liquid fuel, or meniscus may be formed to increase the pressure loss in the fluid as well as the power consumption of the pump, or the size of the anode circulating system may need to be increased.

### BRIEF SUMMARY OF THE INVENTION

According to one aspect of the present invention, there is provides a fuel cell system comprising:

a membrane electrode composite including an anode and cathode which are located opposite each other across an electrolyte membrane;

a lyophobic porous member located adjacent to the anode; and

an anode channel plate located adjacent to the lyophobic porous member and including:
a gas recovery channel through which gas generated by the anode is recovered via a the lyophobic porous member; and
a fuel supply channel through which a liquid fuel is supplied to the anode.

Furthermore, according to another aspect of the present invention, there is provides a method of manufacturing a fuel cell system, the method comprising:

placing a membrane electrode composite including an anode and cathode which are located opposite each other across an electrolyte membrane and placing a lyophobic porous member adjacent to the anode; and

placing an anode channel plate adjacent to the lyophobic porous member after the placing of the lyophobic porous member, the anode channel plate including a gas recovery channel through which gas generated by the anode is recovered and a fuel supply channel through which a liquid fuel is supplied to the anode.

### BRIEF DESCRIPTION OF THE SEVERAL VIEWS OF THE DRAWING

FIG. 1 is a sectional view schematically showing a fuel cell system according to a first embodiment of the present invention; and

FIG. 2 is a sectional view schematically showing a fuel cell system according to a second embodiment of the present invention.

### DETAILED DESCRIPTION OF THE INVENTION

Fuel cell power generating systems according to embodiments of the present invention will be described with reference to the drawings. The same sections and areas in the drawings are denoted by the same reference numerals, and duplicate descriptions are omitted.

### First Embodiment

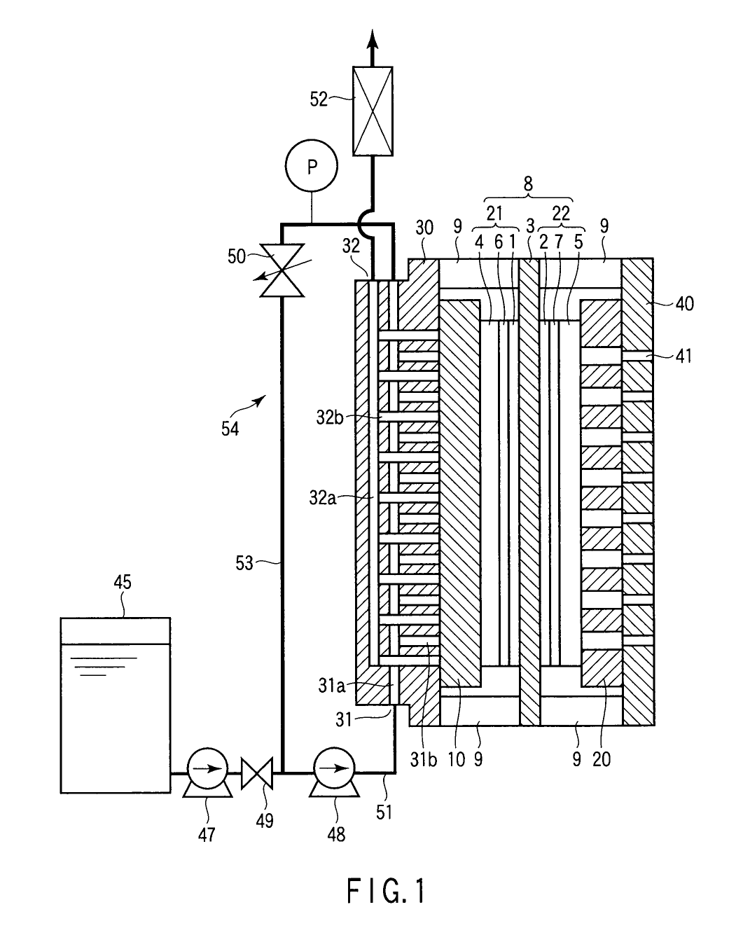

FIG. 1 shows a fuel cell system according to a first embodiment of the present invention. The fuel cell power generating system shown in FIG. 1 comprises a membrane electrode composite 8 having an electrolyte membrane 3 located so as to be sandwiched between an anode and a cathode. The electrolyte membrane 3 is composed of a proton-conductive solid polymer membrane or the like. The anode 21 is composed of an anode catalyst layer 1 formed by coating a catalyst on one surface of the electrolyte membrane 3, an anode gas diffusion layer 4 formed outside the anode catalyst layer 1, and the like. The cathode 22 is composed of a cathode catalyst layer 2 formed by coating a catalyst on a surface of the electrolyte membrane 3 which is opposite to the surface on which the anode catalyst layer is formed, a cathode gas diffusion layer 5 formed outside the cathode catalyst layer 2, and the like.

On an anode side of the fuel cell power generating system, a lyophobic porous member 10 is further located in contact with the anode gas diffusion layer 4. An anode channel plate 30 is located in contact with the lyophobic porous member 10. Furthermore, on the cathode side, a cathode channel plate 40 is located opposite to the anode channel plate 30. The lyophobic porous member 10, the membrane electrode composite 8, and the like are arranged between the anode channel plate 30 and the cathode channel 40. Furthermore, the electrolyte membrane 3, the anode channel plate 30, and the cathode channel plate 40 are sealed by a gasket 9 provided around the periphery of the membrane electrode composite 8. The membrane electrode composite 8 is sealed between the anode channel plate 30 and the cathode channel plate 40 in a liquid tight manner.

The fuel cell power generating system comprises, for example, a fuel tank 45 in which a liquid fuel such as high-concentration methanol is stored, and a fuel supply line 51 through which a fuel is supplied.

A copolymer of tetrafluoroethylene and perfluorovinylethersulfonic acid, for example, Nafion (a registered trademark of Du Pont) is available as the electrolyte membrane 3. Platinum or ruthenium is available as the anode catalyst, which is included in the anode catalyst layer 1. Platinum or the like is available as a cathode catalyst, which is included in the cathode catalyst layer 2. Porous carbon paper or the like is used as the anode gas diffusion layer 4 and the cathode gas diffusion layer 5.

An anode microporous layer 6 made of carbon and subjected to a lyophobic treatment with a submicron pore size and having a thickness of several tens of microns may be placed between the anode catalyst layer 1 and the anode gas diffusion layer 4. A cathode microporous layer 7 made of carbon and having a submicron pore size and a thickness of several tens of microns may be placed between the cathode catalyst layer 2 and the cathode gas diffusion layer 5.

The lyophobic porous member 10 has a surface contacting the anode gas diffusion layer 4 and a surface contacting the anode channel plate 30. That is, the lyophobic porous member 10 is located to be sandwiched between the anode diffusion layer 4 and the anode channel plate 30. At least a part of the surface of the lyophobic porous member 10 which contacts the anode channel plate 30 is preferably made of a conductive material subjected to the lyophobic treatment and having an average pore size of about 1 micrometer.

If a water solution of methanol is used as a liquid fuel, since methanol offers a low surface tension, permeates easily through a dense porous member of an average pore size of the order of submicrometers which has been subjected to the lyophobic treatment with a tetrafluoroethylene resin, for example, Teflon (a trademark of Du Pont). A water solution of methanol of concentration 3M (mol/L) has been found not to permeate through a dense porous member subjected to the lyophobic treatment with a tetrafluoroethylene resin and having an average pore size of smaller than about 1 micrometer.

The lyophobic porous member 10 may be carbon paper made up of carbon fibers subjected to the lyophobic treatment and having pores of pore size several micrometers, a material composed of sintered metal subjected to the lyophobic treatment, or a lyophobic material composed of an electrically conductive porous member of pore size at most several micrometers. At least a surface of the lyophobic porous member 10 which contacts the anode channel plate 30 is preferably formed into a dense porous member layer made of carbon subjected to the lyophobic treatment and having an average pore size of smaller than about 1 micrometer. A smaller pore size hinders the water solution of methanol from permeating through the lyophobic porous member 10.

The anode channel plate 30 has a fuel supply channel 31 through which a liquid fuel flows and a gas recovery channel 32. The fuel supply channel 31 is composed of, for example, a liquid fuel serpentine channel 31a and a fuel supply section 31b. The liquid fuel serpentine channel section 31a is a channel formed of at least one channel along which a liquid fuel flows meanderingly from an upstream toward a downstream. On the other hand, the fuel supply section 31b is formed to branch from the liquid fuel serpentine channel section 31a to extend to the anode gas diffusion layer 4 to feed part of the fuel flowing along the liquid fuel serpentine channel section 31a, to the anode gas diffusion layer 4.

The gas recovery channel 32 is composed of, for example, a gas channel 32a and a gas recovery section 32b. The gas channel 32a is formed to allow gas to flow along the gas channel 32a so as not to cross the fuel supply channel 31. The gas recovery section 32b is formed to recover gas such as CO₂ from the anode gas diffusion layer 4.

A fuel tank 45 is connected to an inlet side of the liquid fuel serpentine channel section 31a via a first pump 47, an opening and closing valve 49, and a second pump 48. Moreover, a fuel supply line 51 extends from an outlet side of the liquid fuel serpentine channel section 31a and connects via a back pressure valve 50 or the like to an upstream of the second pump 48 downstream of the opening and closing valve 49. That is, the second pump 48, the serpentine channel section 31a, and the back pressure valve 50 form a circulatory path downstream of the opening and closing valve 49. In the specification, the circulatory path is referred to as an anode circulating system 54.

The cathode channel plate 40 has intake supply pores 41 through which air is fed to the cathode catalyst layer 2. A porous member 20 having a moisture retaining function to prevent the cathode catalyst layer 2 from drying may be provided between the cathode gas diffusion layer 5 and the cathode channel plate 40.

In this example, the intake supply pores 41 in the cathode channel plate 40 allow air to be fed to the membrane electrode composite 8 through breezing (natural intake scheme).

The term “lyophobicity” as used in the present embodiment means that the water solution of methanol fails to permeate or has difficulty permeating through the porous member or the like. For example, the term “lyophobicity” means that material exhibits lyophobicity when the contact angle of the liquid fuel is smaller than 50°.

Now, a stream of the liquid fuel or the like will be described.

In the system shown in FIG. 1, the liquid fuel stored in the fuel tank 45 is high concentration methanol. The high concentration methanol stored in the fuel tank 45 is fed to the anode circulating system 54. That is, the high concentration methanol is fed to the anode circulating system 54 via the first pump 47, the opening and closing valve 49, and the second pump 48. The high concentration methanol mixes with diluted methanol discharged toward a fuel supply line 51 by the stack. The resulting methanol is fed, at a predetermined concentration, to the inlet side of the liquid fuel serpentine channel 31a of the fuel supply channel 31, formed in the anode channel plate 30.

Part of the liquid fuel fed to the liquid fuel serpentine channel section 31a is fed to the anode gas diffusion layer 4 via the lyophobic porous member 10 subjected to the lyophobic treatment, for example, as methanol and steam (methanol-gas and H₂O-gas). The liquid fuel flowing through the anode diffusion layer 4 is fed to the anode catalyst layer 1 and used for power generation or the like. Part of the liquid fuel permeates through the electrolyte membrane 3 to the cathode side (crossover). The remaining part of the liquid fuel flows to the fuel recovery line 53, connected to the outlet of the liquid fuel serpentine channel 31a. The liquid fuel fed from the outlet of the liquid fuel serpentine channel section 31a is fed to the fuel recovery line 53 and is returned the fuel supply line 51 between the upstream of the second pump 48 and downstream of the opening and closing valve 49 and is fed via the back pressure valve 50 to the inlet of the liquid fuel serpentine channel section 31a again.

On the other hand, CO₂ generated during power generation by the reaction expressed by Formula (1) flows through the gas recovery section 32b and then through the gas channel section 32a without flowing through the fuel supply channel 31 and is then emitted to the exterior of the fuel cell power generating system via a CO₂ exhaust section 52. Consequently, in the serpentine channel section 31a and fuel supply section 31b, formed in the anode channel plate 30, a possible pressure loss resulting from the inflow of CO₂ can be inhibited.

CO₂ is generated by the anode power generation reaction expressed by Formula (1) and flows through the lyophobic porous member 10 via the anode gas diffusion layer 4. At this time, at the interface between the anode channel plate 30 and the lyophobic porous member 10, CO₂ flows preferentially through the gas recovery section 32b. That is, the lyophobicity of the lyophobic porous member 10 causes CO₂ in the lyophobic porous member 10 to form bubbles in the fuel supply section 31b filled with the liquid fuel. However, the bubbles are more likely to flow toward the gas recovery section 32b not filled with the liquid fuel than to flow through the fuel supply section 31b.

As a result, the gas can be prevented from mixing into the liquid fuel flowing through the outlet side of the fuel supply channel 31 in the anode channel plate 30. This inhibits the formation of a gas-liquid two-phase stream. This in turn enables inhibition of a possible increase in the flow velocity of the liquid fuel in the fuel supply channel 31 resulting from an increase in the volume of the liquid fuel caused by the mixture of CO₂ or a possible increase in the pressure loss in the fluid resulting from the formation of meniscus. Therefore, the possible pressure loss in the anode (fuel supply channel 31) can be sharply reduced.

The low flow rate of CO₂ permeating through the anode gas diffusion layer 4 per unit area reduces the possible pressure loss occurring when CO₂ passes through the lyophobic porous member 10. Furthermore, even if the membrane electrode composite 8 is tilted in any direction, the presence of the lyophobic porous member 10 enables the fuel not having reacted with CO₂ to be easily subjected to gas-liquid separation.

The unutilized liquid fuel discharged from the outlet side of the fuel supply channel 31 is circulated to the inlet of the fuel supply channel 31. For the methanol and water consumed by the anode power generation reaction expressed by Formula (1) and the methanol and water crossing over from the anode side to the cathode side, the same amount of methanol and water is fed from the fuel tank 45, in which a high concentration water solution of methanol is stored, to the anode circulating system 54.

Thus, the liquid fuel circulating through the fuel supply channel 31 is a low concentration water solution of methanol with a volume mole concentration of at most 3M. Methanol with a low concentration of at most 3M is unlikely to permeate through the lyophobic porous member 10 and can be prevented from flowing out from the fuel supply channel 31 into the gas recovery channel 32 via the lyophobic porous member 10.

The system according to the embodiment of the present invention allows the gas and the liquid to be separated from each other without the need to separately provide a gas-liquid separator or the like. This enables a further reduction in the size of the fuel cell power generating system.

Furthermore, the liquid fuel flows through the circulatory path as described above, enabling the use of a high concentration fuel.

### Second Embodiment

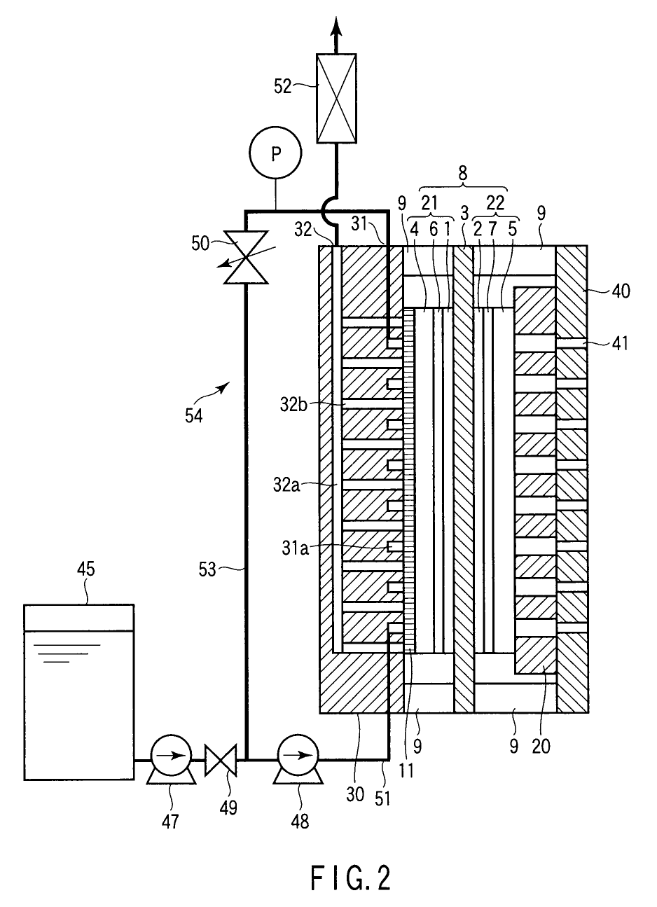

FIG. 2 is a fuel cell system according to a second embodiment of the present invention.

In the fuel cell power generating system shown in FIG. 2, a lyophobic microporous layer 11 subjected to the lyophobic treatment is provided on the side of the anode channel plate 30 on the anode gas diffusion layer 4 of the membrane electrode composite 8. The lyophobic microporous layer 11 is formed as a thin membrane layer formed integrally on the surface of the anode gas diffusion layer 4. That is, in the system shown in FIG. 2, the lyophobic microporous layer 11 subjected to the lyophobic treatment is provided instead of the lyophobic porous member 10, shown in FIG. 1.

Pores of average diameter of at most 1 micrometer are formed in the lyophobic microporous layer 11. Alternatively, the lyophobic microporous layer 11 may be a thin membrane layer made up of a carbon material.

The anode channel plate 30 has the liquid fuel serpentine channel section 31a, forming a serpentine shape, and the gas recovery channel 32. As is the case with the first embodiment, the gas recovery channel 32 is composed of the gas channel 32a and the gas recovery section 32b.

The liquid fuel serpentine channel section 31a is formed to extend along the lyophobic microporous layer 11. Moreover, the liquid fuel serpentine channel section 31a is formed such that the liquid fuel filled in the channel contacts the lyophobic microporous layer 11.

CO₂ generated by the anode power generation reaction and passing through the lyophobic microporous layer 11 flows preferentially through the gas recovery section 32b without flowing through the liquid fuel serpentine channel section 31a. CO₂ flowing through the gas recovery section 32b passes through the gas channel 32a and is emitted to the exterior of the fuel cell power generating system through the CO₂ exhaust section 52.

### Other Embodiments

The description of the embodiments is an example for the description of the present invention and does not limit the invention described in the claims. Furthermore, the configuration of each section of the present invention is not limited to the above-described embodiments but can be varied within the technical scope described in the claims.

The configuration of the fuel supply channel 31 and gas recovery channel 32 is not limited to the serpentine type. The serpentine type is only an example, and the fuel supply path 31 and gas recovery channel 32 of various configurations can be employed.

Furthermore, liquids other than methanol, for example, carbonated hydrogen, and ether may be used as the liquid fuel.

According to the present invention, gas such as CO₂ is inhibited from flowing into a line through which a liquid fuel flows to reduce a possible pressure loss, enabling a reduction in the size of the fuel cell power generating system.

What is claimed is:

1. A fuel cell system comprising:
a membrane electrode composite including an anode, cathode, and an electrolyte membrane sandwiched between the anode and the cathode;
a lyophobic porous member located adjacent to the anode; and
an anode channel plate located adjacent to the lyophobic porous member and including:
a gas recovery channel through which gas generated by the anode is recovered via a the lyophobic porous member; and
a fuel supply channel through which a liquid fuel is supplied to the anode.

2. The fuel cell power generating system according to claim 1, wherein the lyophobic porous member is a thin membrane layer formed on a surface of the anode which is opposite to a surface of the anode which contacts the electrolyte membrane, and is configured to be integrated with the membrane electrode composite.

3. The fuel cell power generating system according to claim 1, wherein the lyophobic porous member includes a carbon material in which a large number of pores of average pore size at most 1 micrometer are formed.

4. The fuel cell power generating system according to claim 1, wherein the fuel is a water solution of methanol of concentration at most 3M.

5. The fuel cell power generating system according to claim 1, wherein the fuel supply channel has inlet and outlet ports, and the fuel cell power generating system further comprises:
a fuel supply line supplying the liquid fuel to the inlet port; and
a fuel recovery line to which the liquid fuel is recovered from the outlet port and is fed to the fuel supply line.

6. A fuel cell system comprising:
a membrane electrode composite including an anode, cathode, and an electrolyte membrane sandwiched between the anode and the cathode;
a lyophobic microporous layer subjected to the lyophobic treatment which is provided on the anode; and
an anode channel plate located on the lyophobic microporous layer and including:
a gas recovery channel through which gas generated by the anode is recovered via a the lyophobic porous member; and
a fuel supply channel through which a liquid fuel is supplied to the anode.

7. The fuel cell power generating system according to claim 6, wherein the lyophobic microporous layer is a thin membrane layer formed on a surface of the anode which is opposite to a surface of the anode which contacts the electrolyte membrane, and is configured to be integrated with the membrane electrode composite.

8. The fuel cell power generating system according to claim 6, wherein the lyophobic microporous layer includes a carbon material in which a large number of pores of average pore size at most 1 micrometer are formed.

9. The fuel cell power generating system according to claim 6, wherein the fuel is a water solution of methanol of concentration at most 3M.

10. The fuel cell power generating system according to claim 6, wherein the fuel supply channel has inlet and outlet ports, and the fuel cell power generating system further comprises:
a fuel supply line supplying the liquid fuel to the inlet port; and
a fuel recovery line to which the liquid fuel is recovered from the outlet port and is fed to the fuel supply line.

11. A method of manufacturing a fuel cell system, the method comprising:
providing a membrane electrode composite including an anode, cathode, and an electrolyte membrane sandwiched between the anode and the cathode
locating a lyophobic porous member adjacent to the anode; and
placing an anode channel plate adjacent to the lyophobic porous member after the locating of the lyophobic porous member, the anode channel plate including a gas recovery channel through which gas generated by the anode is recovered and a fuel supply channel through which a liquid fuel is supplied to the anode.
